(19) United States
(12) Patent Application Publication
(10) Pub. No.: US 2015/0183299 A1
(43) Pub. Date: Jul. 2, 2015

(54) AIR-CONDITIONER, IN PARTICULAR FOR A MOTOR VEHICLE

(71) Applicant: RENAULT S.A.S., Boulogne-Billancourt (FR)

(72) Inventors: Stephane Talaucher, Bonnelles (FR); Pascal Pencole, Plaisir (FR)

(73) Assignee: RENAULT S.A.S., Boulogne-Billancourt (FR)

(21) Appl. No.: 14/412,544

(22) PCT Filed: Jun. 27, 2013
(86) PCT No.: PCT/FR2013/051505

§ 371 Date: Jan. 29, 2015

(30) Foreign Application Priority Data
Jul. 4, 2012 (FR) 1256413

(51) Int. Cl. B60H 1/34

(52) U.S. Cl. CPC B60H 1/34

(57) ABSTRACT

The invention relates to an air-conditioner for a motor vehicle, said air-conditioner including an air-outlet opening surrounded by a first rim on which an axial-compression sealing gasket is to be arranged. The first rim comprises a first bearing strip which is substantially planar or which can be developed as portions of planar strips. A circumferential assembly groove, enabling a first rib of a complementary duct of the air-outlet opening to be axially inserted therein, extends through the bearing strip.

The invention relates to air-conditioners, and in particular air-conditioners for motor vehicles.

An air-conditioner for a motor vehicle communicates, in terms of the air, with the inside of the passenger compartment of the vehicle via orifices, in particular orifices formed in the dashboard of the vehicle.

The seal between the air-conditioner and the dashboard is then usually ensured by foam gaskets placed on a docking edge of the air-conditioner and pressed axially between the air-conditioner and the dashboard.

To reduce the manufacturing costs of the vehicle, a single model of air-conditioner can be used for different models of vehicle.

Dashboard geometry differs from vehicle to vehicle. An air-conditioner designed to be pressed against one type of dashboard may be incompatible with direct assembly on a dashboard of another model.

Furthermore, the design priorities of each vehicle model may result in the air-conditioner being moved away from the dashboard.

To enable a given air-conditioner to be used on different models of dashboard, one or more connection parts between the dashboard and the air-conditioner may be created, these connection parts being pressed against the dashboard and the air-conditioner using foam gaskets.

Since the linear price of foam gaskets is relatively high, potentially increasing in proportion to the complexity of the required geometry, the use of the connection part is however costly.

Moreover, placing foam gaskets at the two linking ends of the connection part can limit the rigidity of the unit, foam gaskets having limited shear strength.

The invention is intended to propose an interface system between an air-conditioner and a dashboard, or between an air-conditioner and another body element of the passenger compartment, which enables a degree of modularity when using a given air-conditioner on different vehicles, limiting the cost of the interface between the air-conditioner and the dashboard and keeping the assembly sufficiently rigid.

For this purpose, the invention proposes an air-conditioner, in particular for a motor vehicle, comprising an air outlet orifice surrounded by a first edge comprising a first bearing strip that is substantially flat or formed of flat-strip portions. Formed in flat-strip portions means that a sealing gasket can be placed on the bearing strip, the face of said sealing gasket touching the bearing strip being a ribbon that is flat and flexible in the longitudinal direction of same, i.e. different lengthways portions can be placed in different planes.

The entire circumference of the bearing strip has a groove that can receive axially a rib of a complementary duct of the air outlet orifice. Air outlet orifice means an orifice used to diffuse the air from the air-conditioner to the outside of the air-conditioner. Such an orifice may be used to draw air in the passenger compartment of the vehicle without thereby moving outside the scope of the invention. Advantageously, one of the openings of the complementary duct of the air outlet orifice can be pressed substantially airtightly against the bearing strip of the orifice, such as to duct the air entering or leaving the orifice. This enables the air-conditioner to be used for different vehicle layouts. In one layout, the air-conditioner is assembled on a dashboard against which it bears via a single gasket seal line. In another layout, the air-conditioner bears against the dashboard by means of the complementary duct. Preferably, the circumferential groove extends over at least one quarter of the circumference of the air outlet orifice. According to a preferred embodiment, the circumferential groove extends around the entire circumference of the air outlet orifice. According to another advantageous embodiment, a group of orifices of the air-conditioner is surrounded by a circumferential groove, with at least some of the portions of the bearing strip located between the different orifices of the group having no circumferential groove. According to a preferred embodiment, the housing of the air-conditioner may be an injected-plastic part, the depth of the groove may be substantially equal to the width of the groove, and may be substantially equal to the thickness of the air-conditioner next to the bearing strip. This provides a good compromise between the airtightness of the air-conditioner-duct assembly, and the difficulty of inserting the groove of the duct into the groove of the air-conditioner. The width of the groove may be between 0.7 and 2 times the average thickness of the air-conditioner next to the bearing strip. Preferably, the width and the depth of the groove are substantially constant. The depth of the groove may be between 1 and 1.5 times the width of the groove.

The circumferential groove may typically run around the bearing strip at a substantially constant distance from the contour of the air outlet orifice. There may nonetheless be local variations within the scope of the invention. Such local variations may for example make it possible to limit the total length of the groove if the contour of the orifice is angular, and/or has local projections/indentations towards the center of the orifice.

The air-conditioner may include one or more centering patterns extending from the bearing strip in a substantially axial direction, placed between the contour of the air outlet orifice and the groove, the axial height of the centering patterns being greater than or equal to the depth of the groove.

The contour of the orifice may be surrounded by a second rib extending axially beyond the bearing surface by an axial height greater than or equal to the depth of the groove. The second rib may thus be used as a centering pattern. According to an advantageous embodiment, the second rib is a rib of substantially constant thickness surrounding the air outlet orifice. The second rib may be located in a prolongation of a wall of a duct opening into the orifice.

According to an advantageous embodiment, the width of the bearing strip outside the groove is at least equal to the width of the bearing strip between the contour of the orifice and the groove. This enables the sealing gasket to be positioned across the groove, such that the gasket surrounds the centering patterns. This provides a sufficient surface on the outer periphery of the gasket either for compression of the gasket or for contact with the complementary duct to keep same in alignment with the desired axis of same.

According to another advantageous embodiment, the width of the bearing strip between the contour of the orifice and the groove is at least equal to the width of the bearing strip outside the groove. If the bearing strip extends radially towards the center of a duct of the air-conditioner as far as the air outlet orifice, this layout facilitates the assembly, by pressing, of the groove of the complementary duct in the groove of the air-conditioner, a somewhat “peripheral” position of the groove limiting the axial deviation of the bearing strip during assembly.

The “at least equal width” applies to the majority of angular positions in relation to an axis of the orifice for which the orifice is effectively surrounded by a groove.

Advantageously, the bearing strip has at least two local first assembly lobes extending from the average width of the bearing strip that can receive attachment means passing through the bearing strip. The through-attachment means may be screws or rivets. The lobe may be perforated or have a threaded seat designed to hold a screw. According to other alternative embodiments, the attachment lobes may be dimensioned and positioned in appropriate places to enable welding assembly to be undertaken using these lobes (for example vibration, ultrasound or interface-heating welding) between the lobes and lobes of the complementary duct. Preferably, the complementary duct has second assembly lobes that can be positioned opposite the first assembly lobes.

The air-conditioner may be part of an assembly including a complementary duct with a second end edge that can be assembled substantially airtightly at the outlet of the orifice, by insertion, on at least one portion of the periphery of the duct, of a rib extending axially from the second end edge.

The second edge may include a second bearing strip complementary to the first bearing strip, and the complementary duct may include, at the end of same opposite the second bearing strip, a third bearing strip able to receive an axial-compression sealing gasket.

Bearing strip complementary to the first bearing strip means a second bearing strip that can bear axially, over the majority of the surface of same (for example over more than 70% of the surface of same), against the first bearing strip.

According to an alternative embodiment, the air-conditioner may not include centering patterns on the first bearing strip, and include centering patterns extending axially from the second bearing strip, the centering patterns being placed radially inside the assembly rib and having an axial height greater than this latter.

According to an alternative embodiment, the air-conditioner according to the invention may include a plurality of air outlet orifices, a group of said air outlet orifices being surrounded by a single assembly groove able to receive axially a rib of a complementary part of the group of air outlet orifices. Each orifice may be complementary to a specific duct of the part, the seal at the gaps between the different orifices being provided either by portions of the groove and supplementary ribs, or by a portion of the axial compression gasket placed on a portion of the bearing strip separating the two orifices.

Other objectives, features and advantages of the invention are set out in the description below, given purely by way of non-limiting example and in reference to the attached drawings, in which:

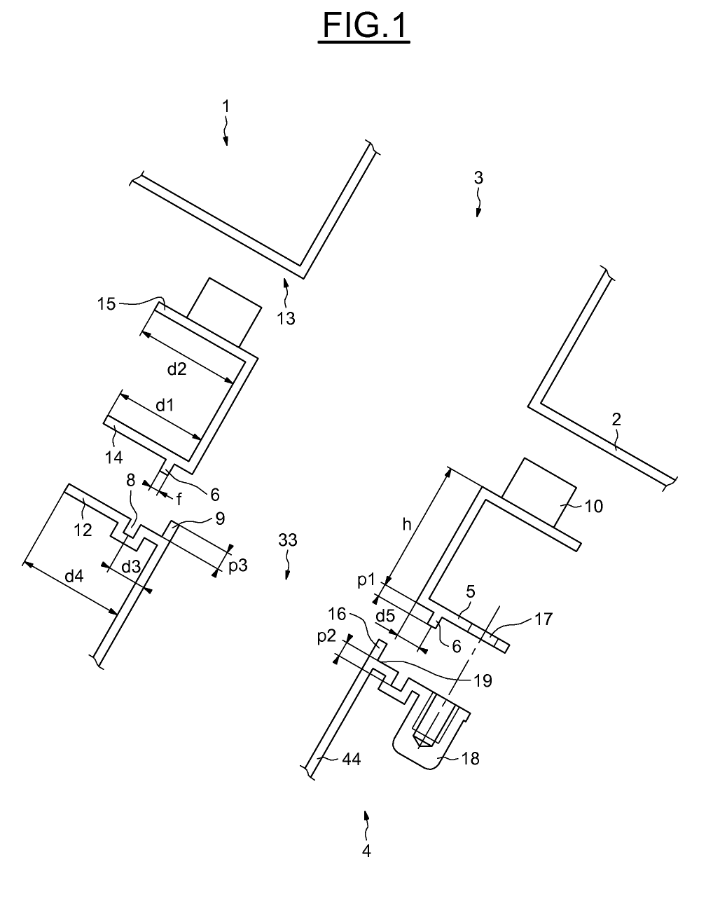

FIG. 1 is a simplified exploded partial cross section of a docking zone of an air-conditioner according to the invention,

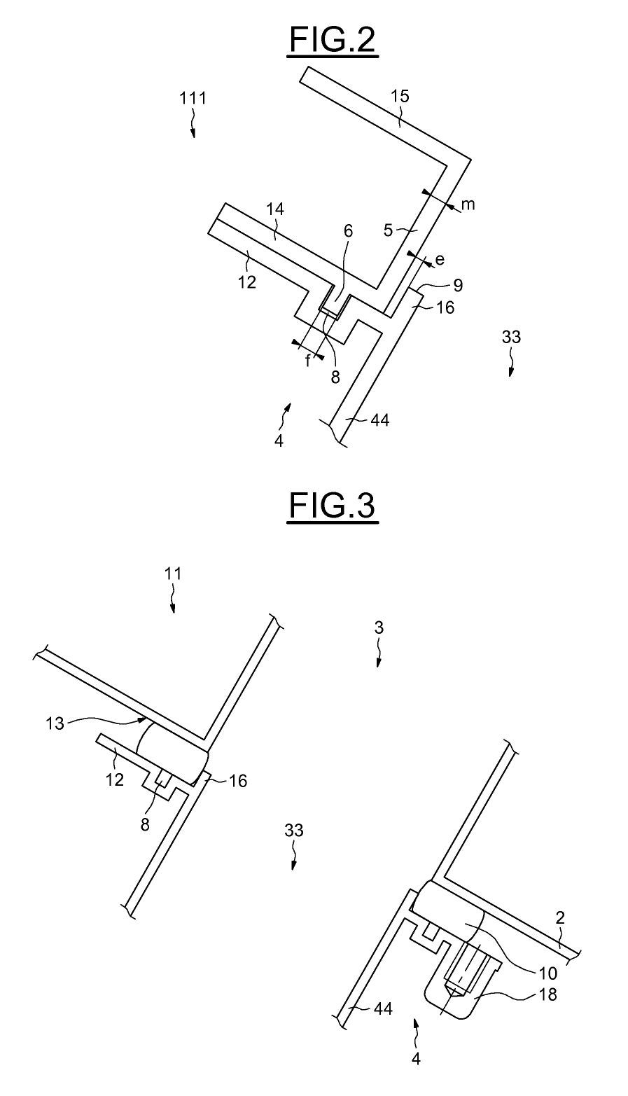

FIG. 2 is a simplified cross section of a docking zone of an air-conditioner according to the invention, including a connection part,

FIG. 3 is a simplified cross section of a docking zone of an air-conditioner according to the invention, assembled directly on a dashboard.

As shown in FIG. 1, the air-conditioning assembly 1 includes a dashboard 2, a portion of the top shell of which can be seen here, in which there is a ventilation opening 3, an air-conditioner 4 and a connection part 5.

The dashboard 2 includes a docking zone 13 about the ventilation opening 3.

A foam gasket 10 is pressed against this docking zone 13 to provide a seal between the ventilation opening 3 of the dashboard 2 and a duct delimited by the connection part 5.

The connection part 5 in the form of a duct complementary to the docking zone 13, and complementary to the orifice 33 of the air-conditioner, links the dashboard 2 and the air-conditioner 4.

Throughout the text, radial direction shall mean a radial direction in relation to an axis of the duct, parallel to an assembly direction of the connection part 5 on the air-conditioner 4. Axial direction shall mean this assembly direction.

The gasket 10 is compressed between the connection part 5 and the docking zone 13 of the dashboard 2. The seal between the connection part 5 and the air-conditioner 4 is provided by inserting a first axial rib 6 of the connection part 5 into a circumferential groove 8 of the air-conditioner 4, surrounding the orifice 33 of the air-conditioner.

The air-conditioner includes a first bearing strip 12, that forms a substantially flat zone or at least a zone formed of flat-strip portions about the orifice 33.

The connection part 5 includes a second bearing strip 14, that forms a substantially flat zone or at least a zone formed of flat-strip portions about the orifice 33.

The first bearing strip 12 and the second bearing strip are complementary, i.e. they can bear axially against one another over the majority of the surfaces of same (for example over more than 70% of the surface of each strip).

The connection part 5 is aligned with the desired axis of the outlet of the orifice 33 by pressing the second bearing strip 14 of the connection part against the first bearing strip 12 of the air-conditioner.

The connection part 5 is also rigidly connected axially to the air-conditioner 4 by means for example of screws or rivets (not shown) passing through the second bearing strip 14, through a screw hole 17 in the connection part, and engaging in a screw seat 18 formed in the bearing strip 12 of the air-conditioner and forming an overthickness in relation to said bearing strip. According to other alternative embodiments, lobes with no overthickness may be provided for rivet attachment, or lobes with no perforations may be provided for plastic-on-plastic welding attachments using known methods.

There is a centering pattern 16 in the form of a rib 9 running alongside the orifice 33 of the air-conditioner. This centering pattern has an axial height p3 greater than the axial height p1 of the first rib 6, intended for insertion into the duct formed by the connection part 5 before the first rib 6 is inserted into the groove 8 and comes into contact with the first bearing strip 12.

For example, the height p3 of the centering pattern 16 may be greater than or equal to the depth p2 of the groove 8. The depth p2 of the groove 8 may be slightly greater than the height pl of the first rib 6, such as to leave an axial assembly clearance during insertion of the first rib 6 into the groove 8, and to guarantee good contact between the first bearing strip 12 and the second bearing strip 14.

FIG. 2 shows an air-conditioning assembly 111 according to the invention, including the air-conditioner 4 in FIG. 1 assembled with the connection part 5 in FIG. 1.

The connection part 5 can for example be made of injected plastic, and the rib 6 may have a radial width f in the same order of magnitude as the average thickness m of the remainder of the injected part 5.

The axial height pl of the rib may then be substantially of the same order of magnitude as the radial width f of the rib.

The bearing strip 12 of the air-conditioner may also be made of injected plastic, or of metal alloy. The dimensions of the groove 8 are designed to receive the first rib 6 with a minimum essential clearance at the base of the groove to ensure good contact between the first bearing strip 12 and the second bearing strip 14. The width of the groove 8, as well as any clearance angle of same, are selected to ensure that the rib 6 can be inserted into the groove 8 with almost no effort, while limiting air leaks between the rib and the groove. As an initial approximation, the radial width f of the rib 6 can be considered to be equal to the radial width of the groove 8.

The centering patterns 16 can form a continuous rib all around the orifice 33, or can form distinct protuberances about the orifice 33.

In the example shown, the rib 9 forming a centering pattern is located in the prolongation of a wall 44 forming an internal duct of the air-conditioner opening out into the orifice 33. The first bearing strip 12 is then supported by this wall 44 inside the orifice 33, and overhangs towards the outside of the orifice 33.

According to other alternative embodiments, the first bearing strip 12 can form a circumferential strip overhanging the center of the orifice 33.

The distance d3 (shown in FIG. 1) between the center of the groove 8 and the inside edge of the orifice 33 of the air-conditioner is such that the gasket 10 can be positioned across the groove 8, being in contact throughout the entire surface of same on either side of the groove, i.e. excluding the groove zone.

When there are centering patterns 16, the distance d3 must be such that the gasket 10 can be placed across the groove 8 without being interfered with by the centering patterns 16.

If there is no centering pattern, the distance d3 may for example be between 3 and 6 mm. If there is a centering pattern, the distance d3 must be calculated from the circumferential base 19 (indicated in FIG. 1) of the centering patterns 16. The width of the rib 6 and the width of the groove 8 may typically be between 1 and 3 mm, and preferably between 1 and 2 mm.

The radial width of the first bearing strip 12 may typically be between 1 and 2 cm, such as to leave sufficient width for compression of the gasket 10, without using too much material to manufacture the bearing strip 12.

As shown in FIG. 1, the second bearing strip 14 may have a radial width d1 that is less than or equal to the radial width d4 of the first bearing strip 12. The width of same may be substantially equal to the first bearing strip 12 to hold it better on the axis of the connection part 5, or it may be slightly narrower to save on materials. The distance d5 between the middle of the rib 6 in relation to and the inside of the duct delimited by the connection part 5 is such that the connection part 5 is seated in the groove 8 of the air-conditioner, leaving a radial clearance e between the internal wall of the duct and the centering patterns 6 of the air-conditioner.

This clearance may for example be less than or equal to 1 mm. The axial height h of the connection part 5 varies as a function of the geometry of the vehicle, and may for example be between 3 and 20 cm, for example between 5 and 10 cm.

The connection part 5 may have, at the end thereof opposite the second bearing strip 14, a third bearing strip 15 able to receive the axial-compression sealing gasket 10.

The radial width d2 of the third bearing strip 15 of the connection part 5 may be substantially equal to the width d4 of the first bearing strip, since this width is determined by the bearing width required to position a given type of gasket 10.

The connection part may be made of one or more portions, for example two injected half-shells joined at a plane passing substantially through an axis of the duct. The two half-shells may for example be assembled by welding.

FIG. 3 shows the air-conditioner 4 according to the invention built into an air-conditioning assembly 11 without a connection part. In this case, the air-conditioning assembly includes a dashboard 2 that bears, by means of a foam gasket 10, directly against the bearing strip 12 of the air-conditioner 4. The gasket 10 is then held via the internal periphery of same by centering patterns 16, straddling the groove 8 by extending radially on either side of same, having sufficient excess compression width to ensure it does not extend outside the bearing strip 12 of the air-conditioner.

The invention is not limited to the example embodiments described, and may take the form of numerous alternative embodiments.

The connection part 5 may for example be docked with the air-conditioner 4 by a rib 6 that only extends around a portion of the periphery of the orifice 33. The connection part 5 may include a duct with a non-rectilinear axis.

The air-conditioner may therefore include a groove 8 that only extends around a portion of the circumference of the orifice 33. In this case, the seal between any connection part 5 and the air-conditioner may be provided in part using the rib 6, and in part using foam gaskets placed on the rest of the bearing strip 12.

This saves on the price of the foam gasket over at least one portion of the width of the perimeter of the orifice 33.

A rib-plus-groove seal can also be used about a group of orifices of the air-conditioner. A reduced seal can also be tolerated between the ducts of the connection part connected to different orifices, or otherwise foam gaskets can be used at the borders between different orifices.

The air-conditioner according to the invention, combined with one or more connection-part geometries, can therefore be used for different vehicle layouts, while limiting additional costs related to ensuring the seal around the connection part. The air-conditioner according to the invention ensures good mechanical strength of the air-conditioner/connection part/dashboard assembly.

1. An air-conditioner, in particular for a motor vehicle, comprising an air outlet orifice surrounded by a first edge comprising a first bearing strip that is substantially flat or formed of flat-strip portions, characterized in that the bearing strip has a circumferential assembly groove that can receive axially a first rib of a complementary duct of the air outlet orifice.

2. The air-conditioner as claimed in claim 1, characterized in that the circumferential groove of the bearing strip is located at a substantially constant distance from the contour of the air outlet orifice.

3. The air-conditioner as claimed in claim 1, including one or more centering patterns extending from the bearing strip in a substantially axial direction, placed between the contour of the air outlet orifice and the groove, the axial height of the centering patterns being greater than or equal to the depth of the groove.

4. The air-conditioner as claimed in claim 3, characterized in that the contour of the orifice is surrounded by a second rib extending axially beyond the bearing surface by an axial height greater than or equal to the depth of the groove.

5. The air-conditioner as claimed in claim 1, characterized in that the width of the bearing strip outside the groove is at least equal to the width of the bearing strip between the contour of the orifice and the groove.

6. The air-conditioner as claimed in claim 1, characterized in that the width of the bearing strip between the contour of the orifice and the groove is at least equal to the width of the bearing strip outside the groove.

7. The air-conditioner as claimed in claim 1, characterized in that the bearing strip has at least two local first assembly lobes extending from the average width of the bearing strip that can receive through-attachment means.

8. The air-conditioner as claimed in claim 1, also including a complementary duct with a second end edge that can be assembled substantially airtightly at the outlet of the orifice, by insertion, on at least one portion of the periphery of the duct, of a first rib extending axially from the second end edge.

9. The air-conditioner as claimed in claim 8, characterized in that the second edge includes a second bearing strip complementary to the first bearing strip, and the complementary duct includes, at the end of same opposite the second bearing strip, a third bearing strip able to receive an axial-compression sealing gasket.

10. The air-conditioner as claimed in claim 1, including a plurality of air outlet orifices, a group of orifices being surrounded by a single assembly groove able to receive axially a rib of a complementary part of the group of air outlet orifices.
